(19) United States
(12) Patent Application Publication
(10) Pub. No.: US 2013/0305931 A1
(43) Pub. Date: Nov. 21, 2013

(54) BEVERAGE CONTAINER WITH INTEGRATED TEA/COFFEE FILTER

(71) Applicants: Christopher M. Pattison, Rochester, NY (US); Mark R. Stechschulte, Rochester, NY (US)

(72) Inventors: Christopher M. Pattison, Rochester, NY (US); Mark R. Stechschulte, Rochester, NY (US)

(73) Assignee: Xerox Corporation, Norwalk, CT (US)

(21) Appl. No.: 13/472,794

(22) Filed: May 16, 2012

(51) Int. Cl. A47J 31/00

(52) U.S. Cl. 99/295

(57) ABSTRACT

A beverage cup is disclosed. The beverage cup includes a receptacle with a bottom wall, an open top, and a sidewall between the bottom wall and the open top. The beverage cup also includes a filter packet with a top surface and a bottom surface connected to the top surface around a periphery thereof. A predetermined amount of flavor containing materials is contained within the filter packet. An adhesive portion is on the bottom wall of the filter packet. The filter packet is attached to the bottom wall by the adhesive portion.

### BACKGROUND

Embodiments herein generally relate to beverage containers and, in particular, to a beverage container having coffee or tea in a filter integrated into the container.

Upon ordering hot tea at an international beverage chain, it was found that the barista provided the hot tea in a first cup 10 with the tea bag string 13 and label 16 leading out from under the lid 19. Additionally, to prevent the label 16 from dangling around and interfering with consumption of the beverage, the first cup 10 was inserted into a second cup 22 with the string 13 and label 16 tucked in, as illustrated in FIG. 1. The issue with this is twofold—one, this essentially wastes a second cup just to avoid the nuisance of the tea bag label from interfering with the beverage consumption; and two, the string interferes with the seal of the lid and allows hot liquid to leak out from under the lid. This results in an unsatisfied customer experience.

The embodiments described below address such issues around having a tea bag.

### SUMMARY

In view of the foregoing, disclosed herein are embodiments for a beverage container for hot or cold beverages with the tea/coffee filter material integrated into the cup. This single unit beverage container reduces the inventory—instead of two parts (cup and tea bag), it is only one part for vendors to carry. It also eliminates the issues described above with the need for additional cups to tie down the label, removes the string as an impingement to obtaining a proper seal with the lid, and prevents having the label dangle in the drinker's face.

The tea leaves, coffee grounds, etc., sit at the bottom of the cup and directly above that is the filter material that is sealed to the internal circumference of the container to prevent the grounds from escaping. Water easily passes through this membrane to steep or brew. A simple swirling motion is enough to distribute the flavor adequately.

According to an embodiment herein, a beverage cup is disclosed. The beverage cup comprises a receptacle with a bottom wall, an open top, and a sidewall between the bottom wall and the open top. The beverage cup further comprises a filter packet with a top surface and a bottom surface connected to the top surface around a periphery thereof. A predetermined amount of flavor containing materials is contained within the filter packet. An adhesive portion is on the bottom surface of the filter packet. The filter packet is attached to the bottom wall by the adhesive portion.

According to another embodiment herein a device for preparing a beverage is disclosed. The device comprises a filter packet with a top surface and a bottom surface connected to the top surface around a periphery thereof. A predetermined amount of flavor containing materials is contained within the filter packet. An adhesive strip is attached to the bottom surface of the filter packet. The device further comprises a receptacle with a bottom wall, an open top, and a sidewall between the bottom wall and the open top. The filter packet is attached to the bottom wall of the receptacle by the adhesive strip.

According to another embodiment herein, a beverage container is disclosed. The container comprises a filter packet having a top surface, a bottom surface connected to the top surface around a periphery thereof, and a hollow space between the top surface and the bottom surface. A predetermined amount of flavor containing materials is disposed in the hollow space between the top surface and the bottom surface. An adhesive strip is attached to the bottom surface of the filter packet. The container further comprises a disposable drinking receptacle having a bottom wall, an open top, and a sidewall between the bottom wall and the open top. The sidewall defines a rim. The bottom wall and the sidewall are water impermeable and constructed to hold a hot liquid. A lid is sealingly attached to the rim. The filter packet is attached to the bottom wall of the receptacle by the adhesive strip.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is an elevational view of a prior art beverage container;

FIG. 2 is an elevational view of a beverage container according to embodiments herein;

FIG. 3 is an elevational view of a beverage container according to embodiments herein; and

FIG. 4 is a bottom perspective view of a filter packet according to embodiments herein.

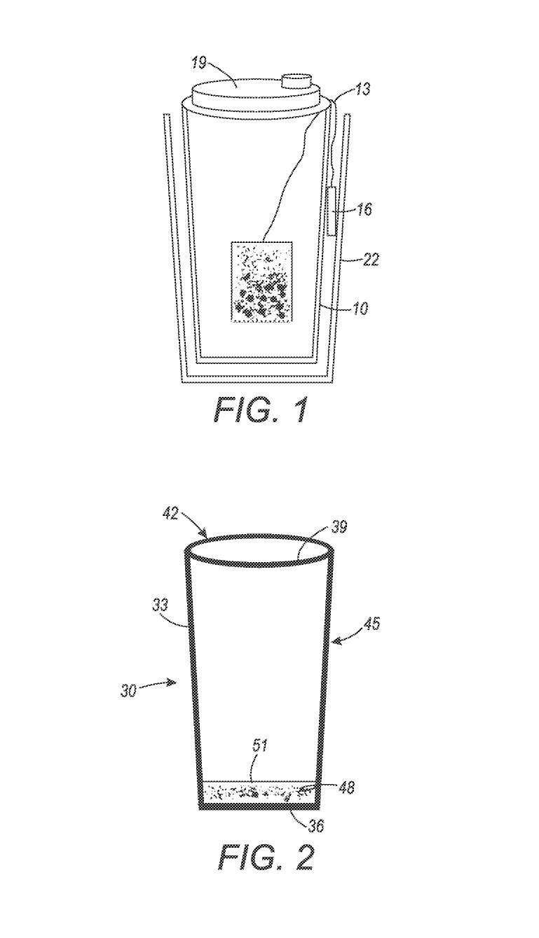

### DETAILED DESCRIPTION

Embodiments herein provide a disposable beverage container that has tea leaves or coffee grounds at the bottom with a filter membrane above the tea leaves or coffee grounds that prevents the grounds from escaping, but allows water to flow through. With embodiments herein, each type of beverage has its own specific cup. The hot beverage industry has been moving “upscale” to attract a wider audience and also target certain people or groups of people. The beverage conveying option described herein provides not only an integrated device but an opportunity to print specific messages or advertising on the cup. For example; when a customer orders a BrandX tea, the cup for serving that tea could have a message on it that relates to people who prefer BrandX tea based. Alternatively, the message could be based on other studies or information about where the tea comes from. Further marketing techniques may be used in that it suggests that if a customer likes BrandX tea, the customer may also like a certain food offering that is sold at the same restaurant. The current option available is unintegrated, meaning that the user receives a generic cup with a specific tea bag, while with the embodiments herein, when a user purchases specific cup, they are also purchasing a specific product within the brand-marked cup.

In addition, common methods place a second cup over the first to contain the dangling label. The presence of the string creates an issue with properly sealing the lid, particularly on a hot beverage cup. The embodiments herein allow users who like to reuse tea bags, for a second cup of tea, to simply remove the lid and refill the container with hot water, thus simplifying the process of reusing a tea bag (when compared to having to remove the tea bag or position it out of the way to refill a standard cup).

FIG. 2 shows a schematic cross section of a beverage cup 30, according to embodiments herein. As illustrated in FIG. 2, beverage cup 30 comprises a receptacle 33 with a bottom wall 36 and a rim 39 defining an open top 42. A sidewall 45 is located between the bottom wall 36 and the open top 42 forming a receptacle 33 that is substantially cylindrical or shaped as an inverted frustum of a cone. According to embodiments herein, the beverage cup 30 further comprises flavor containing materials 48, such as tea leaves, coffee, beverage powder, etc., disposed (meaning positioned, located, etc.) at the bottom of the cup 30. As shown, the bottom wall 36 of the cup 30 is located at the end of the cup 30 that is furthest away from the open top 42 of the cup 30.

Directly above (relative to the bottom of the cup) the flavor containing materials 48, a filter piece 51 is sealed to the internal circumference of the sidewall 45 to prevent the flavor containing materials 48 from escaping. In some non-limiting embodiments, the flavor containing materials 48 may comprise a dry powder. According to embodiments herein, the flavor containing materials 48 are selected so as to readily dissolve in milk, water, or other appropriate liquid.

The filter piece 51 (and corresponding element 78, discussed below) comprises any form of membrane or mesh filter (whether now known or developed in the future) that has openings large enough to allow water to pass, but small enough to keep the solid portions of the flavor containing materials 48 at the bottom of the cup 30 (and out of the liquid that the user will drink). For example, the filter piece 51, 78 can be plastic, paper, cloth, metal, silk, nylon, soilon (made from corn starch), etc. For example, a paper filter could be a blend of wood and vegetable fibers, and can come from bleached pulp. The filter piece 51 has the same shape as the sidewalls of the cup 30. Further, the filter piece 51 can be sealed to the sidewalls of the cup 30 by a heat-sealable thermoplastic such as polyvinylchloride (PVC) or polypropylene as a component fiber on the filter 51 surface. The seal between the filter piece 51 (as well as element 90 discussed below) is high temperature resistant (above 100° C.) so that the filter piece 51 does not disconnect from the cup 30 when boiling water is added, as discussed below.

Hot or cold water, or other appropriate liquid, may be added to the beverage cup 30, which easily passes through the filter piece 51 to steep or brew a desired beverage. A simple swirling motion is enough to distribute the flavor adequately throughout the beverage.

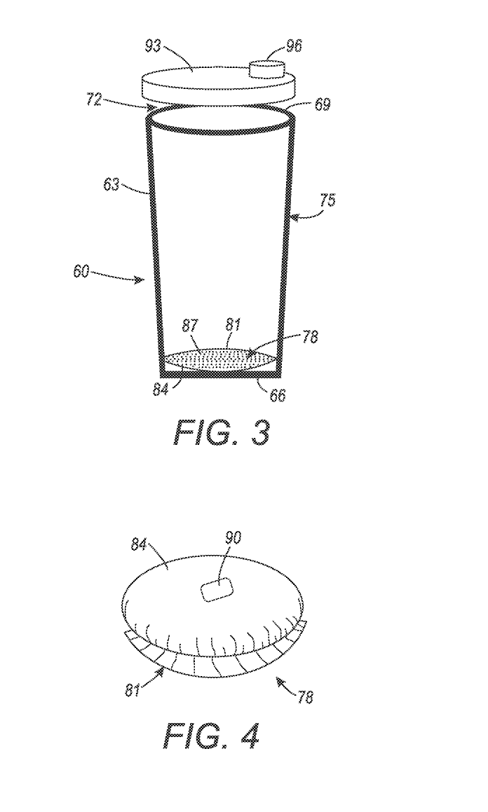

FIG. 3 shows a schematic cross section of another beverage cup 60, according to another embodiment herein. As illustrated in FIG. 3, beverage cup 60 comprises a receptacle 63 with a bottom wall 66 and a rim 69 defining an open top 72. A sidewall 75 is located between the bottom wall 66 and the open top 72 forming a receptacle 63 that is substantially cylindrical or shaped as an inverted frustum of a cone. The beverage cup 60 further comprises a filter packet 78 with a top surface 81 and a bottom surface 84 connected to the top surface 81 around a periphery thereof.

A predetermined amount of flavor containing materials 87, such as tea leaves, coffee, beverage powder, etc. is contained within the filter packet 78. In some non-limiting embodiments, the flavor containing materials 87 may comprise a dry powder. According to embodiments herein, the flavor containing materials 87 are selected so as to readily dissolve in milk, water, or other appropriate liquid. In any case, at least some of the flavor containing materials 48, 78 have particles (leaves, crystals, grains, etc.) that will not dissolve in the liquid and need to be maintained in the filter packet 78 (or below the filter piece 51). Therefore, even if some of the flavor containing materials 48, 78 will fully dissolve in the liquid, some may not and will need to be filtered from the liquid that will be consumed.

An adhesive portion 90 can be located on the bottom surface 84 of the filter packet 78. The filter packet 78 is attached to the bottom wall 66 by the adhesive portion 90. Alternatively, the periphery of the filter packet 78 can be connected to the sidewall of the cup 60 as the filter piece 51 is connected (thereby allowing liquid to flow around both the top 81 and bottom 84 of the filter packet 78, and increasing liquid flow through the filter packet 78).

Hot or cold water, or other appropriate liquid, may be added to the beverage cup 60. The hot or cold water easily passes through the filter packet 78 to prepare a desired beverage.

Referring to FIG. 4, in some embodiments, at least one of the top surface 81 or bottom surface 84 of the filter packet 78 comprises a porous surface. In some embodiments, both the top surface 81 and the bottom surface 84 of the filter packet 78 comprise porous surfaces (such as those mentioned above). The top surface 81 and bottom surface 84 are placed in face to face relation and may be connected around a periphery thereof to form a hollow space between the top surface 81 and the bottom surface 84. According to embodiments herein, a predetermined amount of flavor containing materials 87, such as tea leaves, coffee, beverage powder, etc. is disposed in the hollow space between the top surface 81 and the bottom surface 84. The flavor containing materials 87 may comprise a dry powder. According to embodiments herein, the flavor containing materials 87 are selected so as to readily dissolve in milk, water, or other appropriate liquid.

The top surface 81 or bottom surface 84 of the filter packet 78 comprises any form of membrane or mesh filter (whether now known or developed in the future) that has openings large enough to allow water or other appropriate liquid to pass, but small enough to keep the solid portions of the flavor containing materials 87 out of the liquid that the user will drink. In general, the filter packet 78 may be made of non-toxic porous material possessing a high degree of porosity and sufficient wet-strength to withstand immersion in boiling water. The top surface 81 and the bottom surface 84 of the filter packet 78 should have high normal infusion characteristics and form a multitude of minute fissures upon immersion in water. The filter packet 78 may be sized and configured to fit on the bottom wall 66 of the beverage cup 60.

Thus, the filter packet 78 has all the characteristics of the filter piece 51 discussed above, but comprises a sealed pouch (which could be sealed by any process/material, including the heat-sealable thermoplastic such as polyvinylchloride (PVC) or polypropylene, discussed above). The filter packet 78 can have any shape (round, sphere, square, cubed, triangular, pyramid, etc.) and can include complex folds and other features to increase surface area to promote more liquid flowing through the filter packet 78.

In some non-limiting embodiments, the adhesive portion 90 comprises a pressure sensitive adhesive for adhering the filter packet 78 to the beverage cup 60. The adhesive may be a food-grade adhesive and should retain its adhesive properties throughout a wide range of temperatures, such as from near 0° C. to near 100° C. In some non-limiting embodiments, the adhesive portion 90 may comprise a tape strip or other appropriate device for attaching the filter packet 78 to the beverage cup 60.

According to embodiments herein, examples of flavor containing materials 87 within the filter packet 78 include dehydrated soups; instant coffee, tea or chocolate; soft drink concentrate; or pharmaceutical products. The flavor containing materials 87 may comprise a dry powder. According to embodiments herein, the flavor containing materials 87 are selected so as to readily dissolve in an appropriate liquid. It will be understood by those skilled in the art that the cup 60 may take any desired shape and that the filter packet 78 may take any desired shape. The flavor containing materials 87 may comprise any such beverage concentrate that become usable attractive articles of consumption upon being mixed with hot or cold water, milk or other liquid.

The bottom wall 66 and the sidewall 75 are made from water impermeable material and constructed to hold a hot liquid or a cold liquid for preparing an appropriate beverage. The beverage cup 60 may comprise a lid 93 sized and configured to cover the open top 72, which lid 93 may be sealingly attached to the rim 69. The lid may include an outlet 96 to facilitate drinking from the beverage cup 60.

The beverage cup 60 can be made from a variety of materials including metal such as stainless steel or aluminum, ceramic or porcelain, glass, paper, plastic or plastic-coated paper, foam, or other materials or material compositions. This list is not exhaustive. The various exemplary embodiments herein may be used for preparing a hot beverage or a cold beverage. In some embodiments, to reduce heat conduction to hands and to prevent the hot liquid in the container from hurting the user's hand when holding the beverage cup 60, the beverage cup 60 may comprise a heat insulation member such as a sleeve or coating made from insulation materials connected, either removably or permanently, to the outside of the sidewall 75.

It will thus be seen that a coffee cup and container for a beverage concentrate or the like has been disclosed which is readily adaptable to various forms of single use cups and the like including expanded polystyrene, paper, or thin walled plastic cups.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the embodiments herein should not be implied or imported from any above example as limitations to any particular order, number, position, size, shape, angle, color, temperature, or material.

What is claimed is:

1. A beverage cup, comprising:
a receptacle comprising:
a bottom wall;
an open top; and
a sidewall between said bottom wall and said open top; and
a filter packet comprising:
a predetermined amount of flavor containing materials contained within said filter packet; and
an adhesive portion on said filter packet, said filter packet being attached to said bottom wall by said adhesive portion.

2. The beverage cup according to claim 1, said bottom wall and said sidewall comprising water impermeable material.

3. The beverage cup according to claim 1, further comprising a lid.

4. The beverage cup according to claim 1, at least one of said top surface of said filter packet and said bottom surface of said filter packet comprising porous material.

5. The beverage cup according to claim 1, said flavor containing materials being selected from the group consisting of:
dehydrated soup;
instant coffee;
tea;
chocolate;
soft drink concentrate; and
pharmaceutical products.

6. The beverage cup according to claim 1, said adhesive portion comprising a food-grade adhesive.

7. The beverage cup according to claim 6, said adhesive portion retaining its adhesive properties throughout wide range of temperatures.

8. A device for preparing a beverage, comprising:
a filter packet comprising:
a top surface;
a bottom surface connected to said top surface around a periphery thereof;
a predetermined amount of flavor containing materials contained between said top surface and said bottom surface; and
an adhesive strip attached to said bottom surface of said filter packet; and
a receptacle comprising:
a bottom wall;
an open top; and
a sidewall between said bottom wall and said open top,
said filter packet being attached to said bottom wall of said receptacle by said adhesive strip.

9. The device for preparing a beverage according to claim 8, at least one of said top surface of said filter packet and said bottom surface of said filter packet comprising porous material.

10. The device for preparing a beverage according to claim 8, said flavor containing materials being selected from the group consisting of:
dehydrated soup;
instant coffee;
tea;
chocolate;
soft drink concentrate; and
pharmaceutical products.

11. The device for preparing a beverage according to claim 8, said adhesive strip comprising a food-grade adhesive.

12. The device for preparing a beverage according to claim 11, said adhesive strip retaining its adhesive properties throughout a wide range of temperatures.

13. The device for preparing a beverage according to claim 8, said bottom wall and said sidewall comprising water impermeable material.

14. The device for preparing a beverage according to claim 8, further comprising a lid.

15. A container for hot or cold beverages, comprising:
a filter packet comprising:
a top surface;
a bottom surface connected to said top surface around a periphery thereof and having a hollow space between said top surface and said bottom surface;
a predetermined amount of flavor containing materials disposed in said hollow space between said top surface and said bottom surface; and
an adhesive strip attached to said bottom surface of said filter packet;
a disposable drinking receptacle comprising:
a bottom wall;
an open top; and
a sidewall between said bottom wall and said open top, said sidewall defining a rim,
said bottom wall and said sidewall being water impermeable; and
a lid sealingly attached to said rim,
said filter packet being attached to said bottom wall of said receptacle by said adhesive strip.

16. The container according to claim 15, at least one of said top surface of said filter packet and said bottom surface of said filter packet comprising porous material.

17. The container according to claim 15, said flavor containing materials being selected from the group consisting of:
dehydrated soup;
instant coffee;
tea;
chocolate;
soft drink concentrate; and
pharmaceutical products.

18. The container according to claim 15, said adhesive strip comprising a food-grade adhesive.

19. The container according to claim 18, said adhesive strip retaining its adhesive properties throughout a wide range of temperatures.

20. The container according to claim 15, said bottom wall and said sidewall being constructed to hold one of a hot liquid and a cold liquid.
